(19) United States
(12) Patent Application Publication
(10) Pub. No.: US 2014/0347855 A1
(43) Pub. Date: Nov. 27, 2014

(54) LED LUMINAIRE

(71) Applicant: Luca PIETRELLA, LORETO (IT)

(72) Inventor: Luca Pietrella, Loreto (AN) (IT)

(21) Appl. No.: 14/362,705

(22) PCT Filed: Dec. 6, 2012
(86) PCT No.: PCT/IT2012/000368

§ 371 Date: Jun. 4, 2014

(30) Foreign Application Priority Data
Dec. 7, 2011 (IT) AN2011A000163

(51) Int. Cl. F21K 99/00; F21V 29/00

(52) U.S. Cl. CPC F21K 9/50; F21V 29/22; F21Y 2101/02
USPC 362/247; 362/294; 362/299; 362/301

(57) ABSTRACT

A LED luminaire has a first printed circuit board (PCB) and a second PCB spaced in such manner to generate an empty gap. Spacers are interposed between the first PCB and second PCB in such manner to keep them spaced. A printed circuit is obtained on the internal side of the first PCB. At least one LED is mounted on a pad of the printed circuit, in such manner that light emitted by the LED is subject to multiple reflections between the metal layers of the first PCB and second PCB and reflected light comes out of the gap, illuminating the surrounding space.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application for industrial invention relates to a LED luminaire.

2. Description of Related Art Including Information Disclosed Under 37 CFR 1.97 and 37 CFR 1.98.

Various types of LED luminaires are known on the market. These luminaires generally comprise one or more LEDs mounted on a printed circuit board and a cover made of transparent material for passage of light emitted by the LED.

In order to improve the luminous efficiency of the luminaire, LEDs are disposed inside a reflecting body in order to take advantage of light reflection.

The reflecting body is generally given the shape of a paraboloid and LEDs are provided in the paraboloid focal position.

Traditional printed circuit boards are generally used to mount LEDs, being provided with metal coating on one side only, whereon pads are obtained for LED connection. Given the fact that the LED dissipates a considerable amount of heat, in LED luminaires of known type heat sinks are used, which are generally composed of aluminum supports.

These types of known LED luminaires are impaired by drawbacks due to high production and assembly costs because of additional components, such as domes of transparent materials, parabolic reflectors and heat sinks.

US2008/212319 discloses a LED luminaire that comprises a printed circuit plate whereon LEDs are mounted.

The purpose of the present invention is to eliminate the drawbacks of the prior art by devising a LED luminaire that is efficient, reliable, versatile, inexpensive, simple to make and assemble.

### BRIEF SUMMARY OF THE INVENTION

These purposes are achieved according to the invention, with characteristics claimed in independent claim 1.

Advantageous embodiments are disclosed in the dependent claims.

The LED luminaire of the invention comprises: a first printed circuit board (PCB) and a second PCB spaced in such manner to generate an empty gap. Each PCB comprises an internal side faced towards the empty gap and an external side faced outwards. Each PCB has a transparent substrate. The first PCB has a reflecting metal layer on the internal side and on the external side; the second PCB has a reflecting metal layer on the internal side and/or external side.

Moreover, the luminaire comprises:
spacers interposed between said first PCB and second PCB in such manner to keep them spaced,
a printed circuit obtained on the internal side of said first PCB, and
at least one LED mounted on a pad of said printed circuit board, in such manner that the light emitted by said LED is subject to multiple reflections between the metal layers of said first PCB and said second PCB and reflected light comes out of said empty space, illuminating the surrounding space.

The advantages of the luminaire of the invention are evident, said invention being able to take full advantage of the PCB technology to obtain both the structural part, the reflecting part and the electric part of a luminaire.

### BRIEF DESCRIPTION OF THE DRAWINGS

Further characteristics of the invention will appear clearer from the detailed description below, which refers to a merely illustrative, not limiting, embodiment illustrated in the attached drawings, wherein:

FIG. 1 is a front exploded perspective view of the various parts of the LED luminaire of the invention;

FIG. 2 is the same view as FIG. 1, except for that it is a back perspective view;

FIG. 3 is a front view of the luminaire of FIG. 1 in assembled condition;

FIG. 4 is a side view of the assembled luminaire of FIG. 1 in assembled condition;

FIG. 5 is an enlarged cross-sectional view of a printed circuit board (PCB) for realization of the LED luminaire of the invention;

FIGS. 6 and 7 are the same views as FIG. 5, showing two manufacturing steps of the PCB of FIG. 5;

FIG. 8 is a bottom view of a LED;

FIG. 9 is a top view of a portion of PCB adapted to receive the LED of FIG. 8, wherein a first embodiment of a heat sink system is illustrated; and

FIG. 10 is a top view of a portion of PCB adapted to receive the LED of FIG. 8, wherein a second embodiment of a heat sink system is illustrated.

### DETAILED DESCRIPTION OF THE INVENTION

Referring to the aforementioned figures, the LED luminaire of the invention is disclosed.

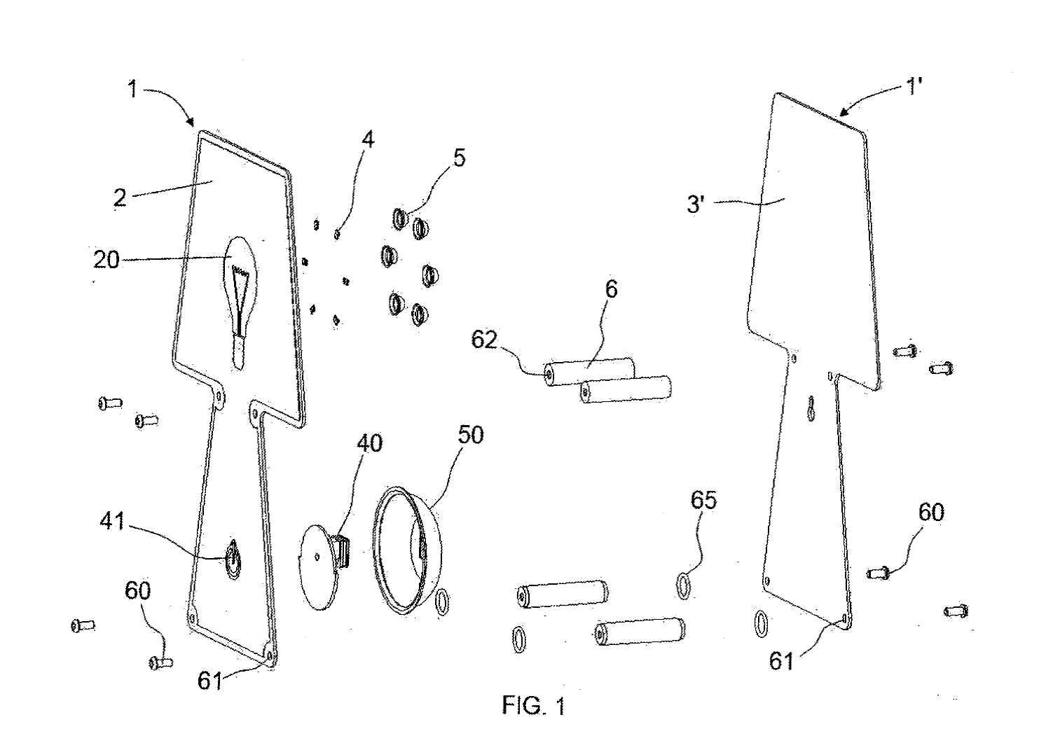

Referring now to FIGS. 1-4, the LED luminaire comprises a first printed circuit board (PCB) (1) and a second PCB (1′) adapted to be parallel and spaced by means of spacers (6), in such manner to generate an empty gap (I) (see FIG. 4).

The first PCB (1) and second PCB (V) respectively comprise an external side (2, 2′) (faced outwards) and an internal side (3, 3′) (faced towards the empty gap (I)), meaning that the internal sides (3, 3′) are in mutual opposite position.

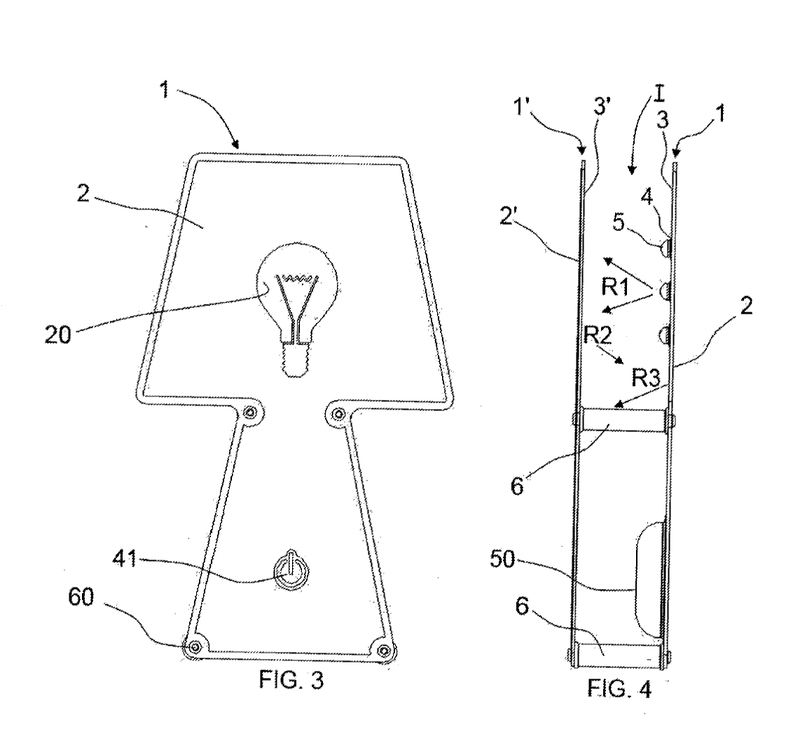

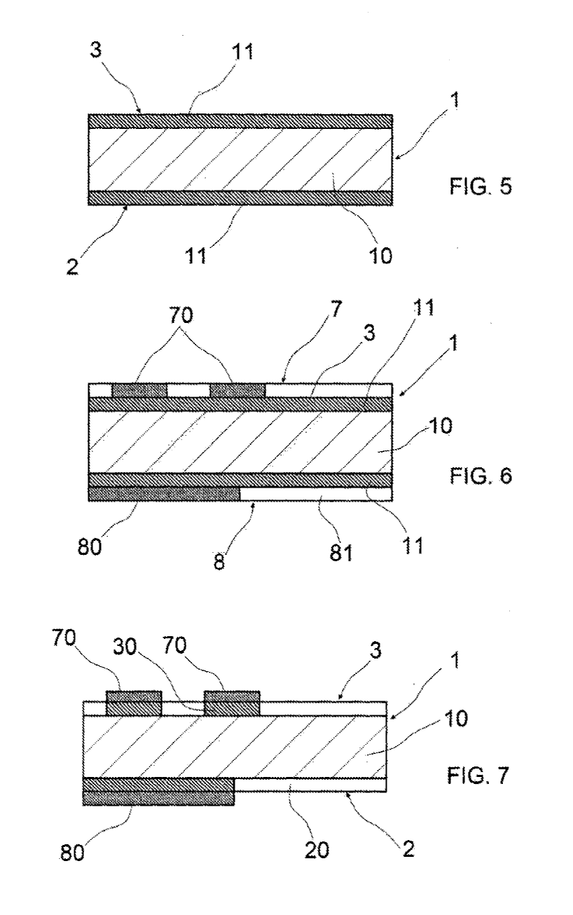

Referring to FIG. 5, the first PCB (1) is double sided and comprises a transparent substrate (10) of insulating material, laminated with two reflecting metal layers (11) of electric conductive material. Although FIG. 5 only shows the first PCB (1), the second PCB (V) has the same structure as the first PCB (1), but can also be one-sided, meaning a transparent substrate (10) with only one metal layer (11) laminated on the external (2′) or internal side (3′) .

The transparent substrate (10) is preferably made of epoxy resin reinforced with fiber glass; the material known on the market as FR-4 can be used. The two metal layers (11) are preferably made of copper. This type of PCB (FR-4 with two-sided or one-sided copper coating) can be found on the market.

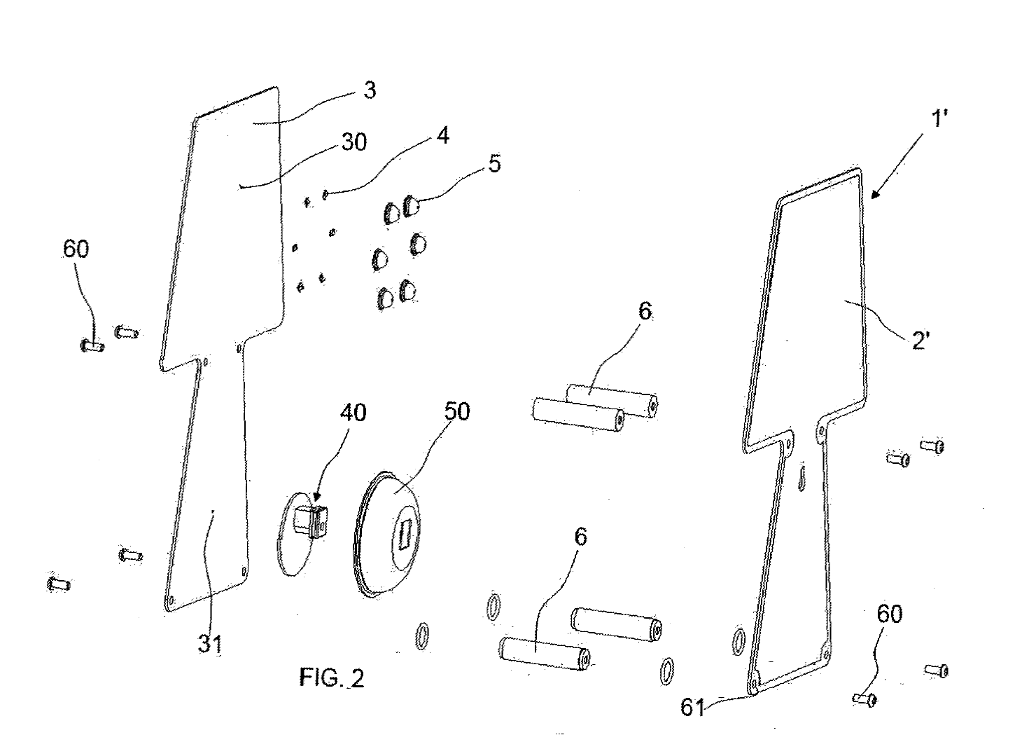

Going back to FIG. 2, on the internal side (3) of the first PCB (1) a printed circuit is obtained for connection and power supply of LEDs (4). Said printed circuit comprises pads (30) whereon LEDs (4) are mounted and conductive tracks for connection of said pads (30). LEDs (4) are protected by suitable covers (5) of transparent material that are fixed to the internal side (3) of the PCB.

The printed circuit obtained on the internal side of the first PCB (1) also comprises a pad (31) for mounting a switch-electrical connector device (40). Referring to FIG. 1, on the external side (2) of the first PCB (1) a button (41) is mounted, being easily accessible for the user, in order to actuate the switch of the device (40). A protection cover (50) is fixed on the internal side (3) of the first PCB (1) to cover the device (40). Electric wires (not shown in the figures) can be connected to the connector of device (40) in order to connect the light source to the electrical mains. In such a case, the device (40) is provided with electrical transformer to transform mains alternate current into direct current to power LEDs. Alternatively, batteries for LED power supply can be integrated in the device (40).

The pad (31) of the device (40) is put in communication with the pads (30) of LEDs (4) by means of conductive tracks obtained on the internal side (3) of the first PCB (1).

Referring to FIGS. 1 and 3, an image (20) is obtained on the external side (2) of the first PCB (1) by removing the metal layer (11) of the external side of the PCB. Said image (20) can have any shape and is designed to allow for passage of light emitted by LEDs. Evidently, the tracks and pads (30, 31) of the printed circuit obtained on the internal side (3) of the PCB are disposed in such manner not to interfere with the image (20) on the external side (2) of the PCB, otherwise, the tracks and pads of the printed circuit would be visible in image (20).

Referring to FIG. 6, in order to obtain the printed circuit on the internal side (3) of the PCB (1), a mask (7) is applied on the internal side (3) of the PCB (1). In the mask (7) all tracks and pads of the printed circuit are printed in positive with suitable ink (70). Instead, the non-printed part of the mask defines the areas from which copper (11) will be removed. Suitable CAD software normally available on the market can be used to print the circuit (70).

Likewise, to obtain the image (20) on the external side (2) of the PCB (1), a mask (8) is applied on the external side (2) of the PCB (1). An image (81) is printed in negative in the mask (8), representing the image (20) to be obtained. In view of the above, the area (80) of the mask outside the image in negative (81) is printed with suitable ink, whereas the image in negative (81) does not contain any ink. Silk-screening techniques can be used to print the image in negative (81).

Referring to FIG. 6, copper (11) is removed by means of etching in areas that are not covered by the ink (70, 80) of the masks. Successively, ink (70, 80) is removed by means of stripping in order to uncover the copper surface (11) on both sides of the PCB.

Now LEDs (4) and the device (40) can be mounted on the printed circuit obtained on the internal side (3) of the PCB. The printed circuit tracks that remain uncovered are coated with white solder-resist both to protect them and improve the reflecting effect.

Although not shown in the drawings, the second PCB (1′) can be identical to the first PCB (1) and can be provided with LEDs or other electronic devices mounted on a printed circuit obtained on the internal side (3′) and images obtained by removing the metal layer on the external side (2′).

Spacers (6) are cylindrical blocks with ends provided with threaded holes (62) wherein screw means (60) are screwed through holes (61) obtained in the PCBs (1, 1′). Gaskets (65) are disposed at the ends of spacers (6) to provide a better seal and avoid damaging the surface of the PCBs.

Spacers (6) can be also made of electric conductive material and can therefore be connected in suitable points of the tracks of the printed circuits obtained in the internal sides (3, 3′) of the two PCBs. In this say, the electric connection between the two printed circuits of the two PCBs is obtained.

Spacers (6) are advantageously made of heat conductive material and disposed in suitable points in contact with the metal layers of the two PCBs, to allow for correct heat distribution between the metal layers of the two PCBs (1, 1′) and therefore for better dissipation of heat generated by LEDs (4). Therefore spacers (6) also act as heat sink

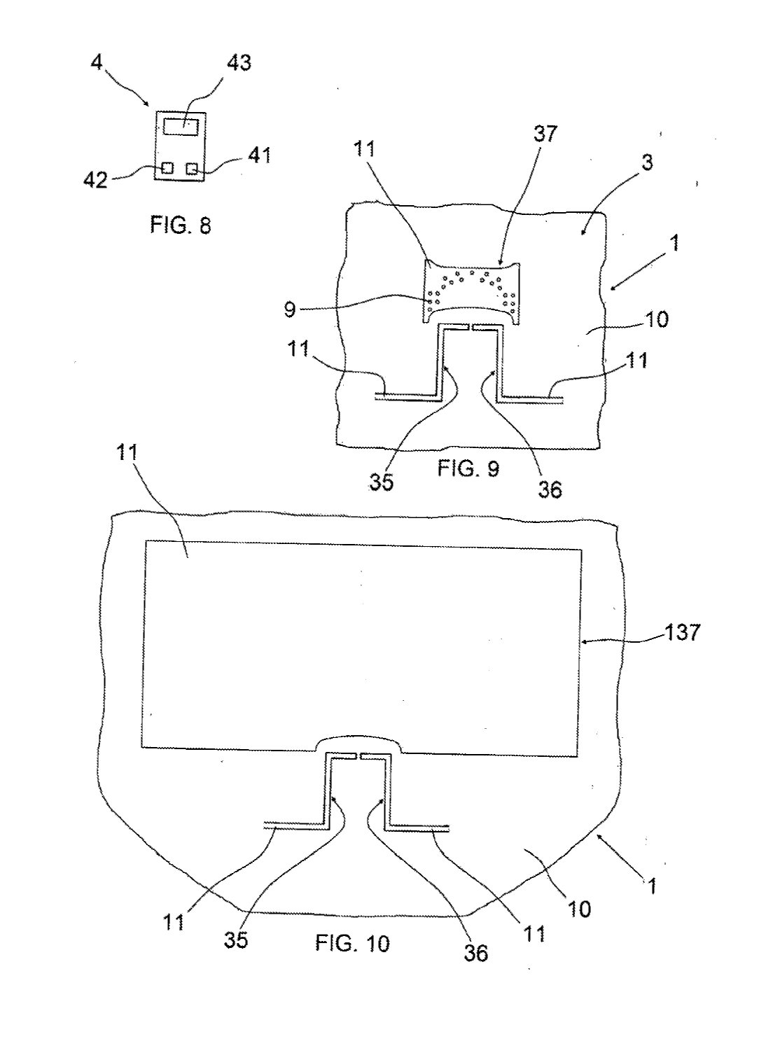

Referring to FIG. 8, the LED (4) comprises a cathode (41), an anode (42) and a pad (43) for heat dissipation.

FIG. 9 shows a portion of the internal side (3) of the first PCB (1), showing a first copper track (35) adapted to be in contact with cathode (41), a second copper track (36) adapted to be in contact with anode (42) and a copper pad (37) adapted to be in contact with pad (43) for heat dissipation of LED. The pad (37) is slightly larger than the LED (4).

In order to improve heat dissipation, the pad (37) of the PCB is provided with a plurality of metallization holes (9) that put the pad (37) in thermal communication with the copper layer provided on the external side (2) of the PCB. In this way, excessive heat in correspondence of the LED (4) is dissipated towards the metal layer of the external side. The realization of metallization holes on a two-sided PCB is known and therefore not illustrated in detail.

Referring to FIG. 10, in order to avoid the making of metallization holes (9), instead of pad (37) a copper plate (137) is obtained, having dimensions at least ten times higher than the surface of the LED (4). In this way, the heat dissipation pad (43) of the LED is positioned on the copper plate (137) dissipating the heat generated by the LED.

In order to additionally improve heat dissipation, a spacer (6) can be disposed in contact with the copper plate (137).

Referring to FIG. 4, the two PCBs (1, 1′) are spaced by a distance preferably comprised between 4 and 6 cm, in such manner that the empty gap (I) has suitable width to generate a multiple reflection of light emitted by LEDs (4).

A case is considered wherein LEDs (4) are only on the first PCB (1) and emit light with light cone of approximately 120°. The light (R1) emitted by LEDs (4) is reflected by the metal layer (11) provided on the internal surface (3′) of the second PCB (1′), thus generating a first ray of reflected light (R2). The ray of reflected light (R2) is refracted by the transparent substrate (10) of the first PCB (1) and reflected by the metal layer (11) provided on the external surface (2) of the first PCB (1), thus generating a second ray of reflected light (R3) that will be in turn reflected by the metal layer of the second PCB and so on, generating a multiple reflection between the two PCBs (1, 1′).

Such multiple reflection phenomenon between the two PCBs (1, 1′) amplifies the luminous emission of the light emitted by the LEDs. Consequently, the reflected light can come out of the lateral borders of said PCB thus allowing for proper lighting of the surrounding space. Moreover, light is refracted by the substrate (10) of the first PCB (1) wherein image (20) is situated, and propagates outwards through image (20) creating a pleasant luminous effect.

Several variations and modifications can be made to the present embodiments of the invention, within the reach of an expert of the field, while still falling within the scope of the invention described in the enclosed claims.

1. A LED luminaire comprising:
a first printed circuit board (PCB) and a second PCB spaced in such manner to generate an empty gap and identify, in each PCB, an internal side faced towards the gap and an external side faced outwards, each PCB having a transparent substrate, the first PCB having a reflecting metal layer on the internal side and on the external side, the second PCB having a reflecting metal layer on the internal side and/or on the external side;
spacers interposed between said first PCB and second PCB in such manner to keep them mutually spaced;
a printed circuit obtained on the internal side of said first PCB;
at least one LED mounted on a pad of said printed circuit, in such manner that light emitted by said LED is subject to multiple reflections between the metal layers of said first PCB and said second PCB and reflected light comes out of said gap, illuminating the surrounding space.

2. The luminaire of claim 1, wherein the luminaire comprises at least one image obtained by removing the metal layer on the external side of said first PCB and/or on at least one side of said second PCB to let LED light refracted by said transparent substrate of the PCB come outside through said image.

3. The luminaire of claim 1, wherein said second PCB has a reflecting metal layer both on the internal side and external side, a printed circuit on the internal side and at least one LED mounted on a pad of said printed circuit on the internal side of the second PCB.

4. The luminaire of claim 3, wherein said spacers are electric wires that put said printed circuit obtained on the internal side of the first PCB in electric communication with said printed circuit obtained on the internal side of the second PCB.

5. The luminaire of claim 1, wherein the luminaire comprises heat sink means adapted to dissipate heat generated by said LED.

6. The luminaire of claim 5, wherein said heat sink means comprise a copper pad obtained on the internal side of said first or second PCB, adapted to come in contact with a heat sink pad of the LED and a plurality of metallization holes obtained on said copper pad in the proximity of the LED to put the copper pad in communication with the copper layer provided on the external side of the PCB.

7. The luminaire of claim 5, wherein said heat sink means comprise a copper plate obtained on the internal side of said first or second PCB and adapted to come in contact with a heat sink pad of the LED, said copper plate having a surface at least ten times higher than the LED.

8. The luminaire of claim 7, wherein said heat sink means comprise at least one spacer disposed in contact with said copper plate.

9. The luminaire of claim 1, wherein said PCBs are parallel and the width of said gap is comprised between 4 and 6 cm.
